(19) United States
(12) Patent Application Publication
(10) Pub. No.: US 2014/0071670 A1
(43) Pub. Date: Mar. 13, 2014

(54) LED LAMP CAPABLE OF INCREASING LIGHT SATURATION

(71) Applicants: CHUNG-CHI LIU, SHENZHEN (CN); HUA-ZHENG LI, SHENZHEN (CN)

(72) Inventors: CHUNG-CHI LIU, SHENZHEN (CN); HUA-ZHENG LI, SHENZHEN (CN)

(73) Assignees: LIGHT-CORE LIMITED, SHENZHEN (CN); SHENZHEN JIAWEI PHOTOVOLTAIC LIGHTING CO., LTD., SHENZHEN (CN)

(21) Appl. No.: 13/609,743

(22) Filed: Sep. 11, 2012

(51) Int. Cl. F21V 7/00

(52) U.S. Cl. 362/235

(57) ABSTRACT

An LED lamp capable of increasing light saturation utilizes a mixing layer to be formed on a reflecting layer since the mixing layer is arranged by multiple dots that are distributed at intervals and formed as a dot-matrix layer. At least one color formed on the dots to present the colored dot-matrix display allows the light beams from the LED lamp to be mixed with the color on the dot-matrix layer and then reflected for promoting the color temperature uniformity of the light beams and decreasing the generation of dark zone, which efficiently provides light beams with a uniform saturation for illuminating.

### BACKGROUND OF THE INVENTION

1. Field of the invention

The present invention relates to a design of an LED lamp, particularly to an LED lamp capable of increasing light saturation.

2. Description of the Related Art

Referring to FIG. 1, a conventional LED lamp 1 comprises a seat body 11 including an accommodating chamber 111, a light module 12 protruded from the accommodating chamber 111, and a fin set 13 connected to the light module 12. Wherein, the light module 12 has an electrical-connecting circuit board 121, an optical reflector disposed on the circuit board 121, and at least one LED unit 123 disposed on the circuit board 121. Further, a wall 1221 is formed in the optical reflector 122, a room 1222 is encircled by the wall 1221, and a reflecting layer 1223 (shown by a sketch) is disposed on the wall 1221. Herein, the reflecting layer 1223 usually adopts a glossy plane. Accordingly, the LED unit 123 is electrified via the circuit board 121 to emit light via the reflecting layer 1223 and illuminate where the light emits. Herein, the conventional LED unit 123 provides uniform light via the reflecting layer 1223 that is formed by coating the wall 1221 with fluorescent powders. However, the uneven coating of the fluorescent powders on the wall 1221 may cause the LED unit 123 to create the uneven color temperature. Thus, in view of the uneven fluorescent powders on the reflecting layer 1223, the fluorescent powders may gradually chip off from the wall 1221 due to a long period of exposure to the high temperature derived from the LED unit 123. As a result, the LED unit 123 is hard to provide the uniform illumination via the conventional reflecting layer 1223. Also, a poor spotlighting effect, a circle of haze, and a dark zone may adversely occur due to the unequal illumination of the LED lamp 1.

### SUMMARY OF THE INVENTION

It is therefore the purpose of this invention to provide an LED lamp capable of increasing light saturation via arranging a mixing layer that is formed by a plurality of dots on which at least one color is formed on a reflecting layer, thereby enhancing the light saturation and the preferable illumination of the LED lamp.

The LED lamp in accordance with the present invention comprises a seat body with an accommodating chamber, a light module protruded from the accommodating chamber, and a fin set connected to the light module. Wherein, the light module includes a circuit board, an optical reflector disposed on the circuit board, and at least one LED unit disposed on the circuit board. The optical reflector is provided with a circling wall that defines a hollow room therein. A reflecting layer is formed on the wall. The reflecting layer includes a mixing layer disposed thereon. The mixing layer is established by a plurality of dots at intervals as a dot-matrix layer and at least one color is formed on the dots. By the combination of the reflecting layer and the mixing layer with multiple spaced dots to perform the dot-matrix layer, light beams provided by the LED unit are mixed with the color of the dot-matrix layer and thence reflected to increase the light uniformity, decrease the dark zone, attain the uniform saturation effect, and provide a preferable illumination.

Preferably, the dots are fluorescent.

Preferably, the dots are formed by printing.

Preferably, a transparent unit is connected to a rim of the seat body.

Preferably, the dots are designed in different sizes.

Accordingly, the light generated by the LED unit is mixed with the color presented on the dots that are arranged at intervals as the dot-matrix layer on the reflecting layer and thence reflected, so that the emitted light provides uniform illumination due to refraction of the reflecting layer and the mixing layer, which lessens a dark zone. Therefore, the LED lamp of the present invention illuminates consistently owing to the steady and uniform saturation.

### BRIEF DESCRIPTION OF THE DRAWINGS

FIG. 1 is a schematic view showing a conventional LED lamp;

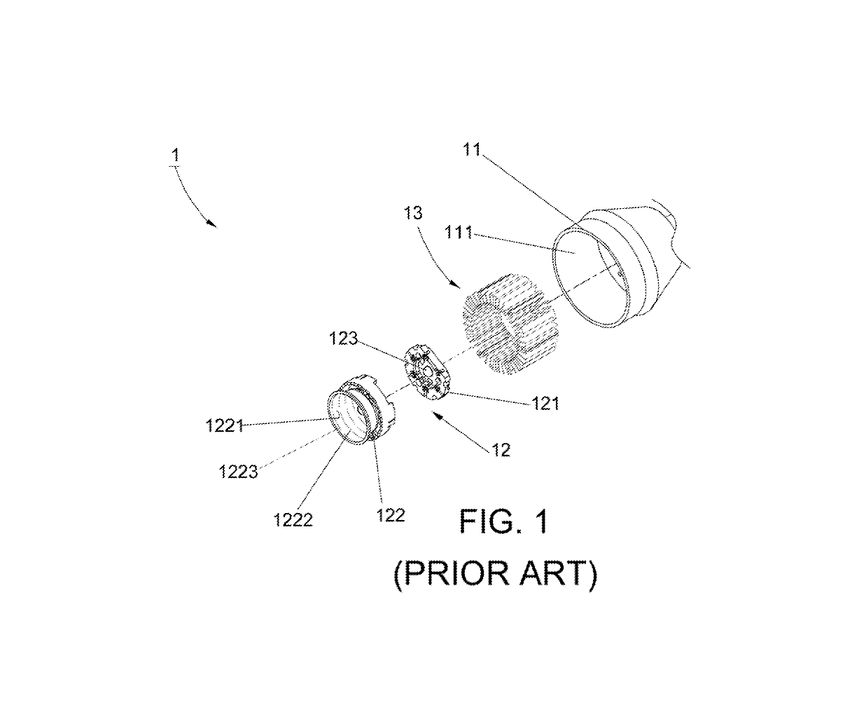

FIG. 2 is a schematic view showing a preferred embodiment of the present invention; and

FIG. 3 is a cross-sectional view showing partial elements of the preferred embodiment of the present invention.

### DETAILED DESCRIPTION OF THE PREFERRED EMBODIMENTS

Wherever possible, the same reference numbers are used in the drawings and the description to refer to the same or like parts.

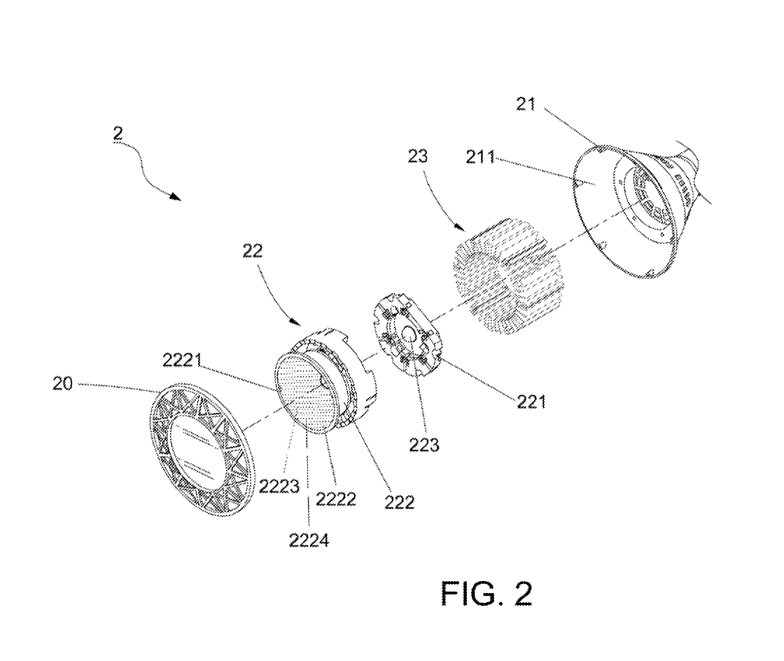

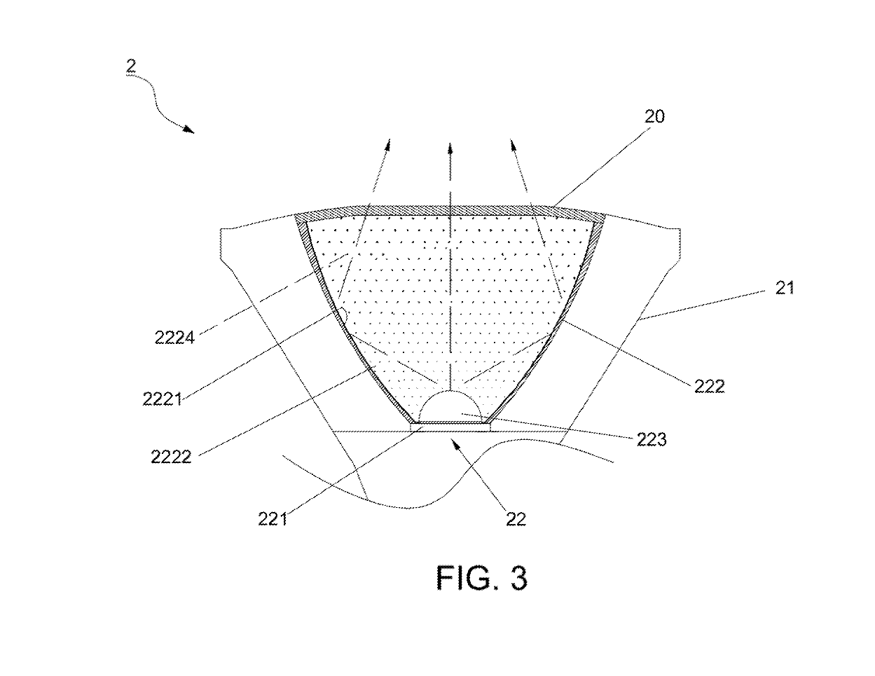

Referring to FIG. 2, a first preferred embodiment of the present invention is shown. An LED lamp 2 capable of increasing light saturation comprises a seat body 21 including an accommodating chamber 211, a light module 22 protruded from the accommodating chamber 211, and a fin set 23 connected to the light module. Wherein, the light module 22 includes an electrical-connecting circuit board 221, an optical reflector 222 disposed on the circuit board 221, and at least one LED unit 223 disposed on the circuit board 221. The optical reflector 222 is provided with a circling wall 2221 that includes a hollow room 2222 formed therein. A reflecting layer 2223 is formed on the wall 2221. Especially, the reflecting layer 2223 includes a mixing layer 2224 disposed thereon. The mixing layer 2224 on the reflecting layer 2223 is established by a plurality of dots at intervals as a dot-matrix layer. On the dots, at least one color is formed. Wherein, the dots are fluorescent, and the dots are preferably formed by printing. Concurrently, the dots are designed in different sizes (as shown in dotted line in FIG. 3), namely the larger dots and smaller dots shade into one another. Light beams provided by the LED) unit 223 are mixed with dots and thence reflected. Accordingly, the larger dots absorb and radiate the light beams, and the reflected light beams are able to present a single color light, a multi-color light, or a synthetic color light. The color light of the LED unit 223 could be freely adjusted in accordance with the size of an object (not shown) that is to be shone, the distance between the object and the LED unit 223, or the practical lighting scope.

Continuingly, a transparent unit 20 is connected to a rim of the seat body 21 for blocking the accommodating chamber 211. As it should be, the transparent unit 20 can be freely adopted in a accordance with practical needs.

Referring to FIG. 3, the LED unit 223 is electrified by means of the electrical communication of the circuit board 221 to provide light beams when a power is given. Thereafter, the light beams pass the reflecting layer 2223 and the mixing layer 2224 and aggregate through the transparent unit 20. Namely, the light beams from the LED unit 223 are mixed with the color of the dot-matrix layer formed by the printed dots and than reflected so as to change a lighting effect. Whereby, the transparent unit 20 gathers the light beams and emits them (as shown by broken lines in FIG. 3) out of the LED lamp 2, which not only prevents the generation of the dark zone and the light flare but allows the light beams from the LED unit 223 to contain uniform and satisfactory saturation and facilitate an even illumination of the place which the light beams illuminates. Accordingly, since the reflecting layer 2223 is defined with the mixing layer 2224, the reflecting layer 2223 does not easily chip off even if the reflecting layer 2223 is continuingly shone under the heating temperature from the LED unit 223. Thus, no chromatic aberration is resulted and the LED lamp 2 provides the favorable illumination.

To sum up, the present invention particularly defines a mixing lever on the reflecting layer. Wherein, the mixing layer is arranged by a plurality of dots that are distributed at intervals for presenting a dot-matrix layer on the reflecting layer. Accordingly, while the light beams from the LED unit is mixed with the color on the dots and reflected, the emitted light shines evenly to all the color temperature to be steady and lessen the dark zone. Thus, the present invention provides the light beams with satisfactory saturation and favorable illumination.

While we have shown and described the embodiment in accordance with the present invention, it should be clear to those skilled in the art that further embodiments may be made without departing from the scope of the present invention.

I claim:

1. An LED lamp capable of increasing light saturation comprising a seat body in which an accommodating chamber is defined, a light module protruded from said accommodating chamber, and a fin set connected to said light module; wherein, said light module including an electrical-connecting circuit board, an optical reflector disposed on said circuit board, and at least one LED unit disposed on said circuit board; said optical reflector being provided with a circling wall where a hollow room is defined; a reflecting layer being formed on said wall;
wherein, a mixing layer is further disposed on said reflecting layer, and said mixing layer is established by a plurality of dots at intervals as a dot-matrix layer; at least one color is formed on said dots; light beams provided by said LED unit are mixed with said color of said dot-matrix layer and reflected, whereby said reflected light beams providing an even saturation are emitted from said LED lamp.

2. The LED lamp as claimed in claim 1, wherein, said dots are fluorescent.

3. The LED lamp as claimed in claim 1, wherein, said dots are formed by printing.

4. The LED lamp as claimed in claim 1, wherein, a transparent unit is connected to a rim of said seat body.

5. The LED lamp as claimed in claim 1, wherein, said dots are designed in different sizes.
